(19) United States
(12) Patent Application Publication
(10) Pub. No.: US 2019/0170952 A1
(43) Pub. Date: Jun. 6, 2019

(54) OPTICAL MODULE

(71) Applicant: FUJITSU LIMITED, Kawasaki-shi (JP)

(72) Inventor: TAKAHIRO OOI, Kawasaki (JP)

(73) Assignee: FUJITSU LIMITED, Kawasaki-shi (JP)

(21) Appl. No.: 16/188,933

(22) Filed: Nov. 13, 2018

(30) Foreign Application Priority Data
Dec. 4, 2017 (JP) 2017-232321

(51) Int. Cl. G02B 6/42

(52) U.S. Cl. CPC G02B 6/4206; G02B 6/4295; G02B 6/4214; G02B 6/425

(57) ABSTRACT

An optical module includes a first light source configured to emit a first light beam, a second light source configured to emit a second light beam, and a lens member configured to include a first lens configured to transmit the first light beam, a second lens provided adjacent to the first lens and configured to transmit the second light beam, and a gap provided between the first lens and the second lens.

### CROSS-REFERENCE TO RELATED APPLICATION

This application is based upon and claims the benefit of priority of the prior Japanese Patent Application No. 2017-232321, filed on Dec. 4, 2017, the entire contents of which are incorporated herein by reference.

### FIELD

The embodiments discussed herein are related to an optical module.

### BACKGROUND

In the related art, there is an optical module that includes, for example, multiple light sources such as laser diodes arranged in parallel in the form of an array, and lenses corresponding to the respective light sources. In addition, there has been known a lens unit which includes a lens array in which multiple pairs of lenses, each of which includes a first lens for forming a contracted inverted image of an object and a second lens for forming an expanded inverted image of the image formed by the first lens, are arranged in a substantially linear shape (see, e.g., Japanese Laid-open Patent Publication No. 2012-189915).

Related techniques are disclosed in, for example, Japanese Laid-open Patent Publication No. 2012-189915.

### SUMMARY

According to an aspect of the embodiments, an optical module includes a first light source configured to emit a first light beam, a second light source configured to emit a second light beam, and a lens member configured to include a first lens configured to transmit the first light beam, a second lens provided adjacent to the first lens and configured to transmit the second light beam, and a gap provided between the first lens and the second lens.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a front view illustrating an example of a microlens according to a first embodiment;

FIG. 2 is a top plan view illustrating an example of the microlens according to the first embodiment;

FIG. 3 is a bottom view illustrating another example of the microlens according to the first embodiment;

FIG. 4 is a top plan view illustrating another example of the microlens according to the first embodiment;

FIG. 5 is a cross-sectional view illustrating another example of the microlens according to the first embodiment;

FIG. 6 is a cross-sectional view illustrating an example of an optical module according to the first embodiment;

FIG. 7 is a cross-sectional view illustrating an example of a part of the optical module according to the first embodiment;

FIG. 8 is a front view illustrating an example of a microlens according to a second embodiment;

FIG. 9 is a top plan view illustrating an example of the microlens according to the second embodiment;

FIG. 10 is a bottom view illustrating another example of the microlens according to the second embodiment;

FIG. 11 is a top plan view illustrating another example of the microlens according to the second embodiment;

FIG. 12 is a cross-sectional view illustrating another example of the microlens according to the second embodiment;

FIG. 13 is a front view illustrating an example of a microlens according to a third embodiment;

FIG. 14 is a top plan view illustrating an example of the microlens according to the third embodiment; and

FIG. 15 is a bottom view illustrating another example of the microlens according to the third embodiment.

### DESCRIPTION OF EMBODIMENTS

In the related art, an oblique light beam incident to a lens leaks to a neighboring lens in some cases. If the light leaks to the neighboring lens, for example, quality of an optical signal deteriorates.

Hereinafter, embodiments of a technology capable of suppressing an oblique light beam incident to a lens from leaking to a neighboring lens will be described in detail with reference to the drawings.

### First Embodiment

### Example of Microlens According to First Embodiment

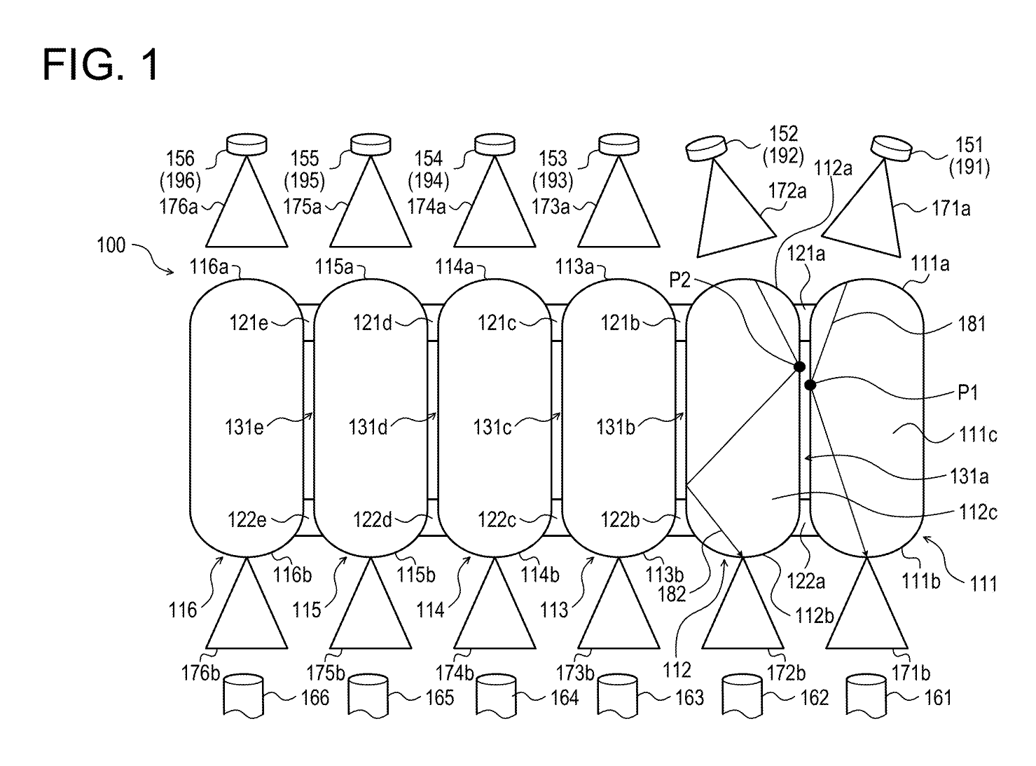

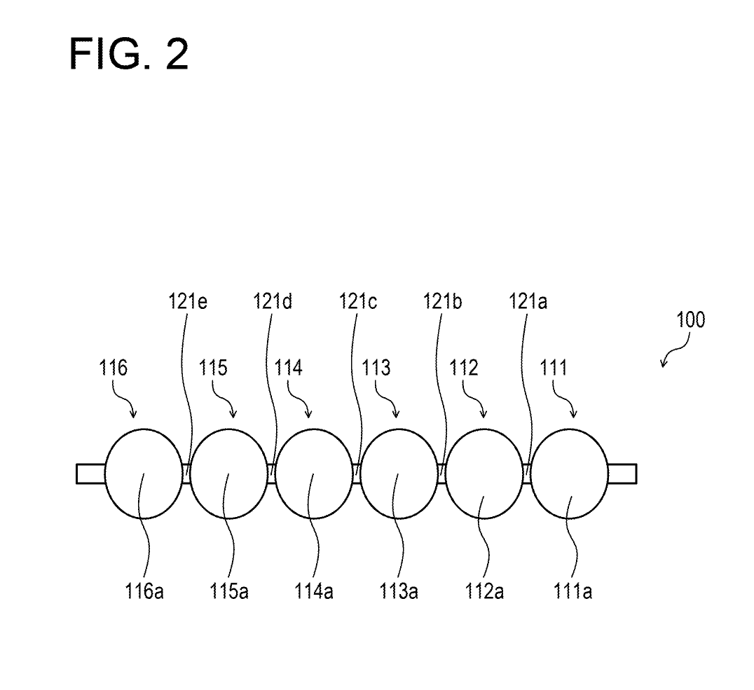

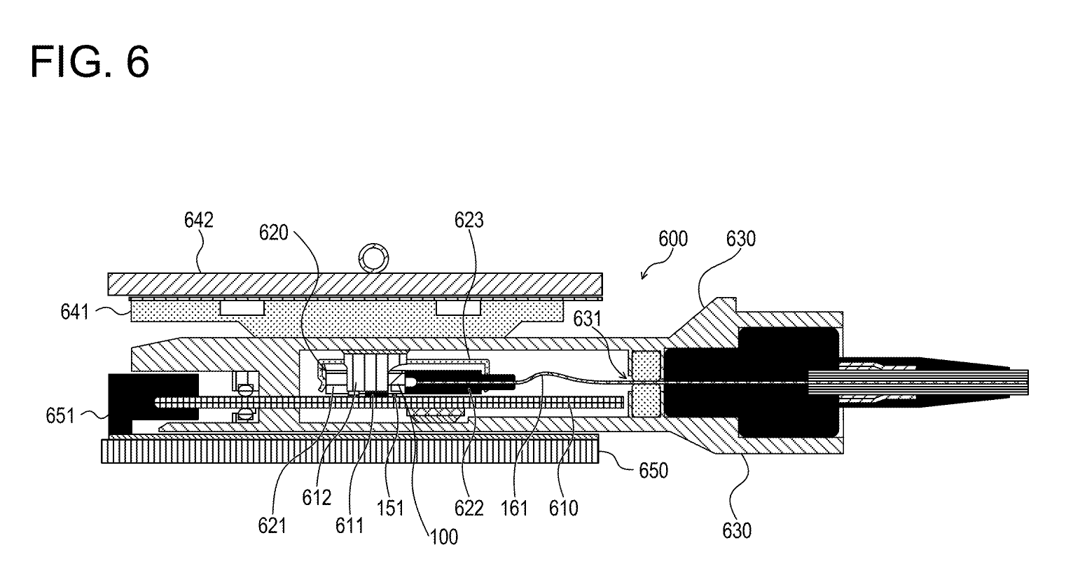

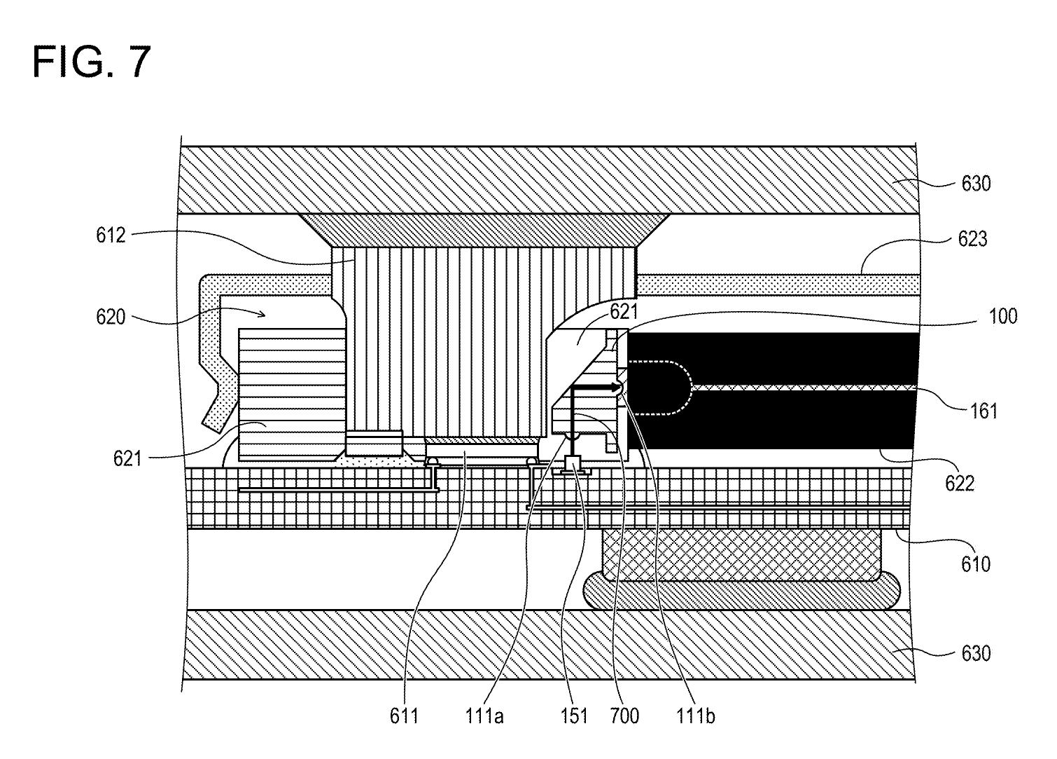

FIG. 1 is a front view illustrating an example of a microlens according to a first embodiment. FIG. 2 is a top plan view illustrating an example of the microlens according to the first embodiment. A microlens 100 according to the first embodiment illustrating FIGS. 1 and 2 is an example of a lens member included in an optical module according to the first embodiment. For example, light emitted from a light source included in the optical module according to the first embodiment, is incident to the microlens 100. The optical module according to the first embodiment will be described below (see, e.g., FIGS. 6 and 7).

The microlens 100 is a one-piece lens member. The one-piece lens member is a single member having a portion that acts as a lens. As illustrated in FIGS. 1 and 2, the microlens 100 has, for example, lens units 111 to 116 arranged in the form of an array. Each of the lens units 111 to 116 is a part of the microlens 100 and acts as a lens.

For example, the lens unit 111 is a lens unit that corresponds to a VCSEL 151 and an optical fiber 161. The VCSEL 151 emits a laser beam 171a to the lens unit 111. VCSEL stands for Vertical Cavity Surface Emitting Laser. For example, the laser beam 171a is an optical signal to be transmitted by the optical fiber 161. The laser beam 171a emitted from the VCSEL 151 is incident to the lens unit 111 from a convex lens portion 111a formed at a portion of the lens unit 111 adjacent to the VCSEL 151. The lens unit 111 emits the laser beam, which has been incident to the lens unit 111, to the optical fiber 161 from a convex lens portion 111b formed at a portion of the lens unit 111 adjacent to the optical fiber 161. For example, the laser beam, which has been incident to the lens unit 111 from the convex lens portion 111a, is transmitted through an intermediate portion 111c between the convex lens portion 111a and the convex lens portion 111b and then emitted from the convex lens portion 111b. A laser beam 171b, which has been emitted from the convex lens portion 111b, is incident to the optical fiber 161. The optical fiber 161 transmits the laser beam, which has been incident to the optical fiber 161, to a corresponding device of the optical module according to the first embodiment.

For example, the lens unit 112 is a lens unit that corresponds to a VCSEL 152 and an optical fiber 162. The VCSEL 152 emits a laser beam 172a to the lens unit 112. For example, the laser beam 172a is an optical signal to be transmitted by the optical fiber 162. The laser beam 172a emitted from the VCSEL 152 is incident to the lens unit 112 from a convex lens unit 112a formed at a portion of the lens unit 112 adjacent to the VCSEL 152. The lens unit 112 emits the laser beam, which has been incident to the lens unit 112, to the optical fiber 162 from a convex lens portion 112b formed at a portion of the lens unit 112 adjacent to the optical fiber 162. For example, the laser beam, which has been incident to the lens unit 112 from the convex lens portion 112a, is transmitted through an intermediate portion 112c between the convex lens portion 112a and the convex lens portion 112b and then emitted from the convex lens portion 112b. A laser beam 172b, which has been emitted from the convex lens portion 112b, is incident to the optical fiber 162. The optical fiber 162 transmits the laser beam, which has been incident to the optical fiber 161, to the corresponding device of the optical module according to the first embodiment.

Similarly, the lens units 113 to 116 are lens units that correspond to VCSELs 153 to 156 and optical fibers 163 to 166, respectively. The VCSELs 153 to 156 emit laser beams 173a to 176a to the lens units 113 to 116, respectively. The laser beams 173a to 176a are optical signals to be transmitted by the optical fibers 163 to 166, respectively. The laser beams 173a to 176a, which have been emitted from the VCSELs 153 to 156, respectively, are incident to the lens units 113 to 116 from convex lens portions 113a to 116a, respectively. The lens units 113 to 116 emit the laser beams, which have been incident to the lens units 113 to 116, respectively, to the optical fibers 163 to 166 from convex lens portions 113b to 116b, respectively. For example, the laser beams, which have been incident to the lens units 113 to 116 from the convex lens portions 113a to 116a, respectively, are transmitted through intermediate portions between the convex lens portions 113a to 116a and the convex lens portions 113b to 116b and then emitted from the convex lens portions 113b to 116b, respectively. The laser beams 173b to 176b, which have been emitted from the convex lens portions 113b to 116b, respectively, are incident to the optical fibers 163 to 166, respectively. The optical fibers 163 to 166 transmit the laser beams, which have been incident to the optical fibers 163 to 166, respectively, to the corresponding device of the optical module according to the first embodiment.

The VCSELs 151 to 156 are examples of the light sources included in the optical module according to the first embodiment. In addition, the optical fibers 161 to 166 are examples of optical transmission paths provided in the optical module according to the first embodiment.

Because the lens units 111 to 116 are made of, for example, resin or glass, a refractive index (absolute refractive index) of each of the lens units 111 to 116 is greater than 1. An example of the refractive index of each of the lens units 111 to 116 is 1.5. In addition, an example of a pitch of each of the lens units 111 to 116 is 250 μm. The pitch of each of the lens units 111 to 116 is, for example, a distance between centers of the convex lens portions of the adjacent lens units, that is, a pitch of the arrangement of the respective lens units. In addition, an example of a diameter of each of the lens units 111 to 116 is 250 μm. In addition, the pitch of each of the lens units 111 to 116 may be greater than, for example, 250 μm in order to provide connecting units 121a to 121e and 122a to 122e and gaps 131a to 131e to be described below.

Each of the connecting unit 121a to 121e and 122a to 122e and each of the gaps 131a to 131e are provided between the adjacent lens units among the lens units 111 to 116 of the microlens 100. Each of the connecting units 121a to 121e and 122a to 122e is a portion that connects the adjacent lens units among the lens units 111 to 116. Here, the connection means the physical connection. The physical connection means, for example, that there is no gap. Since there is the portion that connects the adjacent lens units, the adjacent lens units are fixed to each other by the portion. For example, the connecting units 121a and 122a between the lens unit 111 and the lens unit 112 are portions that connect the lens unit 111 and the lens unit 112. The connecting units 121a to 121e and 122a to 122e may maintain a predetermined pitch of the lens units 111 to 116 and the state where the lens units 111 to 116 are disposed in parallel with one another.

For example, as described below, the VCSELs 151 to 155 are provided on a board included in the optical module according to the first embodiment. In the following description, the board included in the optical module according to the first embodiment is simply referred to as a “board” in some cases.

The VCSELs 151 to 155 are provided on the board to have the same pitch as the lens units 111 to 115. For example, it is assumed that the lens units 111 to 115 are provided to have a pitch of 250 μm. In this case, the VCSELs 151 to 155 are also provided to have a pitch of 250 μm. That is, the pitch of the VCSELs 151 to 155 is 250 μm. The pitch of the VCSELs 151 to 155 is, for example, a distance between centers of laser beam emitting ports of the adjacent VCSELs, that is, a pitch of the arrangement of the respective VCSELs.

For example, when manufacturing the optical module, a manufacturer of the optical module according to the first embodiment positions the microlens 100 so that the laser beams 171a to 175a emitted from the VCSELs 151 to 155 are incident to the lens units 111 to 115, respectively. At the time of the positioning, when the lens unit 111 and the VCSEL 151 are positioned, for example, the lens units 112 to 115 and the VCSELs 152 to 155 are also positioned because of the connecting units 121a to 121e and 122a to 122e. For this reason, according to the microlens 100, it is not necessary to individually position the lens units 111 to 115 and the VCSELs 151 to 155, and as a result, it is possible to reduce the number of positioning processes.

Each of the gaps 131a to 131e is a portion between the adjacent lens units among the lens units 111 to 116, that is, a portion where the adjacent lens units are disconnected from each other. Here, the disconnection means the physical disconnection. The physical disconnection means, for example, that the adjacent lens units are spaced apart from each other. For example, the gap 131a between the lens unit 111 and the lens unit 112 is a portion where the lens unit 111 and the lens unit 112 are disconnected from each other. In addition, each of the gaps 131a to 131e is provided, for example, between the intermediate portions of the adjusted lens units. For example, as illustrated in FIG. 1, the gap 131a between the lens unit 111 and the lens unit 112 is provided between the intermediate portion 111c and the intermediate portion 112c. In addition, the gaps 131a to 131e are filled with, for example, air. In this case, a refractive index (absolute refractive index) of each of the gaps 131a to 131e is about 1 and smaller than the refractive index of each of the lens units 111 to 116.

Therefore, for example, in a case where an oblique light beam, which is oblique with respect to an optical axis of the lens unit 111, is incident to the lens unit 111 and then the oblique light beam reaches a boundary surface between the lens unit 111 and the gap 131a, the oblique light beam is totally reflected toward the lens unit 111 by the boundary surface between the lens unit 111 and the gap 131a. The optical axis is a virtual light ray that represents the light beam passing through an entire optical system. For example, the optical axis is a straight line (main axis) that passes through the center of the lens and is perpendicular to a lens surface. For example, the gap 131a is provided in parallel with the optical axis of the lens unit 111. For example, the optical axis of the lens unit 111 is a straight line that passes through the center of the convex lens portion 111a and the center of the convex lens portion 111b. Since the gap 131a is provided in parallel with the optical axis of the lens unit 111, when the oblique light beam, which has been incident to the lens unit 111 from a light incidence side of the lens unit 111, reaches the boundary surface between the lens unit 111 and the gap 131a, the oblique light beam is, for example, totally reflected to a light emission side of the lens unit 111.

Similarly, it is assumed that the oblique light beams, which are oblique with respect to the optical axes of the lens units 112 to 116, respectively, are incident to the lens units 112 to 116 and then the oblique light beams reach the boundary surfaces between the lens units 112 to 116 and the gaps 131b to 131e. In this case, the oblique light beams are totally reflected toward the lens units 112 to 116 by the boundary surfaces between the lens units 112 to 116 and the gaps 131b to 131e. In addition, for example, the gaps 131b to 131e are provided in parallel with the optical axes of the lens units 112 to 116, respectively. The optical axes of the lens units 112 to 116 are straight lines that pass through the centers of the convex lens portions 112a to 116a and the centers of the convex lens portions 111b to 116b, respectively. Since the gaps 131b to 131e are provided in parallel with the optical axes of the lens units 112 to 116, when the oblique light beams, which have been incident from the light incidence sides of the lens units 112 to 116, reach the boundary surfaces with the gaps 131b to 131e, the oblique light beams are totally reflected toward the light emission sides of the lens units 112 to 116.

The gaps 131a to 131e may be filled with gas other than air, or may be in a vacuum state. As the refractive index of each of the gaps 131a to 131e decreases, a difference between the refractive index of each of the lens units 111 to 116 and the refractive index of each of the gaps 131a to 131e may increase. Therefore, by decreasing the refractive index of each of the gaps 131a to 131e, it is possible to decrease a critical angle set for totally reflecting the oblique light beam, which has been incident to each of the lens units 111 to 116, by the boundary surface with each of the gaps 131a to 131e. For this reason, by decreasing the refractive index of each of the gaps 131a to 131e, it is easy to totally reflect the oblique light beam, which has been incident to each of the lens units 111 to 116, by the boundary surface between each of the lens units 111 to 116 and each of the gaps 131a to 131e. The gaps 131a to 131e are examples of slits which are parallel to the optical axes of the lens units 111 to 116, respectively.

For example, the microlens 100 may be implemented by integrally forming the lens units 111 to 116 and the connecting units 121a to 121e and 122a to 122e by using a mold or the like and by using resin or glass. Therefore, it is possible to easily form the microlens 100 that has the lens units 111 to 116 in which the directions of the optical axes and the pitch are constant, and the connecting units 121a to 121e and 122a to 122e and the gaps 131a to 131e.

In the optical module having the microlens 100 and the VCSELs 151 to 156, the VCSEL 151 may be provided in a state deviating from a regular state. For example, as illustrated in FIG. 1, the VCSEL 151 may be provided obliquely with respect to the lens unit 111 without facing the convex lens portion 111a.

In the case where the VCSEL 151 is provided obliquely with respect to the lens unit 111, a center of the laser beam 171a, which is emitted from the VCSEL 151, is also oblique with respect to the optical axis of the lens unit 111, as illustrated in FIG. 1. As a result, the oblique light beam is incident to the lens unit 111. Further, in this case, an optical path of the oblique light beam, which has been incident to the lens unit 111, is, for example, an optical path indicated by the arrow 181. That is, in this case, the oblique light beam, which has been incident to the lens unit 111, travels in the lens unit 111 first, for example, to a point P1 which is a part of the boundary surface between the lens unit 111 and the gap 131a. Further, the oblique light beam, which has reached the point P1, is totally reflected at the point P1 toward the lens unit 111, travels in the lens unit 111 again, and then is emitted, as the laser beam 171b, from the convex lens portion 111b to the optical fiber 161.

Therefore, according to the microlens 100, since the oblique light beam, which has been incident to the lens unit 111, is totally reflected when the oblique light beam reaches the gap 131a, it is possible to suppress the oblique light beam, which has been incident to the lens unit 111, from leaking to the neighboring lens unit 112. For this reason, according to the microlens 100, it is possible to reduce crosstalk occurring when the oblique light beam, which has been incident to the lens unit 111, leaks to the lens unit 112, and thus it is possible to reduce deterioration in the optical signal caused by the crosstalk.

Similarly, in the optical module having the microlens 100 and the VCSELs 151 to 156, the VCSEL 152 may be provided in a state deviating from a regular state. For example, as illustrated in FIG. 1, the VCSEL 152 may be provided obliquely with respect to the lens unit 112 without facing the convex lens portion 112a.

In the case where the VCSEL 152 is provided obliquely with respect to the lens unit 112, a center of the laser beam 172a, which is emitted from the VCSEL 152, is also oblique with respect to the optical axis of the lens unit 112, as illustrated in FIG. 1. As a result, the oblique light beam is incident to the lens unit 112. Further, in this case, an optical path of the oblique light beam, which has been incident to the lens unit 112, is, for example, an optical path indicated by the arrow 182. That is, in this case, the oblique light beam, which has been incident to the lens unit 112, travels in the lens unit 112 first, for example, to a point P2 which is a part of the boundary surface between the lens unit 112 and the gap 131a. Further, the oblique light beam, which has reached the point P2, is totally reflected at the point P2 toward the lens unit 112, travels in the lens unit 112 again, and then is emitted, as the laser beam 172b, from the convex lens portion 112b to the optical fiber 162.

Therefore, according to the microlens 100, since the oblique light beam, which has been incident to the lens unit 112, is totally reflected when the oblique light beam reaches the gap 131a, it is possible to suppress the oblique light beam, which has been incident to the lens unit 112, from leaking to the neighboring lens unit 111. For this reason, according to the microlens 100, it is possible to reduce crosstalk occurring when the oblique light beam, which has been incident to the lens unit 112, leaks to the lens unit 111, and thus it is possible to reduce deterioration in the optical signal caused by the crosstalk.

A simulation in terms of the amount of crosstalk occurring when the laser beam of the VCSEL 151 leaks to the lens unit 112 was performed on the microlens 100 illustrated in FIG. 1 in respect to a case where the gap 131a is provided and a case where no gap 131a is provided. As a result of the simulation, the amount of crosstalk was 0 dBm in the case where the gap 131a was provided, and the amount of crosstalk was 3.653e−8 dBm in the case where no gap 131a was provided. Here, e−8 means 10 to the power of −8. In addition, the simulations were performed under a condition in which it was assumed that the VCSEL 151 was provided to face the lens unit 111. It is conceivable that a difference in amount of crosstalk between the presence and the absence of the gap 131a becomes greater when it is assumed that the VCSEL 151 is provided in the state deviating from the regular state, as illustrated in FIG. 1.

In the example described above, the VCSELs 151 to 156 are provided as the light sources corresponding to the microlens 100, but the light sources corresponding to the microlens 100 are not limited to the VCSELs 151 to 156. For example, as illustrated in FIG. 1, a PD 191 may be provided instead of the VCSEL 151. PD stands for photodiode. In the case where the PD 191 is provided, the optical fiber 161, for example, outputs the laser beam, which has been incident to the optical fiber 161 from the corresponding device of the optical module according to the first embodiment, to the lens unit 111. The laser beam, which has been emitted from the optical fiber 161, is incident to the lens unit 111 from the convex lens portion 111b. Further, the lens unit 111 outputs the laser beam, which has been incident to the lens unit 111, to the PD 191 from the convex lens portion 111a. The PD 191 receives the light incident to the PD 191.

In the case where the PD 191 is provided, the corresponding device of the optical module according to the first embodiment may receive the laser beam obliquely with respect to the optical fiber 161, or an angle deviation may occur in the optical fiber 161. In this case, the center of the laser beam emitted from the optical fiber 161 is oblique with respect to the optical axis of the lens unit 111. As a result, the oblique light beam may be incident to the lens unit 111, and the oblique light beam, which has been incident to the lens unit 111, may reach the boundary surface between the lens unit 111 and the gap 131a. Even in this case, according to the microlens 100, the oblique light beam, which has reached the boundary surface between the lens unit 111 and the gap 131a, may be totally reflected toward the lens unit 111 by the boundary surface between the lens unit 111 and the gap 131a.

Therefore, according to the microlens 100, even in the case where the PD 191 is provided, it is possible to suppress the oblique light beam, which has been incident to the lens unit 111, from leaking to the neighboring lens unit 112. For this reason, according to the microlens 100, it is possible to reduce crosstalk when the oblique light beam, which has been incident to the lens unit 111, leaks to the neighboring lens unit 112, and thus it is possible to reduce deterioration in optical signal caused by the crosstalk.

Similarly, PDs 192 to 196 may be provided instead of the VCSELs 152 to 156. In the case where the PDs 192 to 196 are provided, the optical fibers 162 to 166, for example, output the laser beams, which have been incident to the optical fibers 162 to 166 from the corresponding device of the optical module according to the first embodiment, to the lens units 112 to 116. The laser beams, which have been emitted from the optical fibers 162 to 166, are incident to the lens units 112 to 116 from the convex lens portions 112b to 116b. Further, the lens units 112 to 116 output the laser beams, which have been incident to the lens units 112 to 116, to the PDs 192 to 196 from the convex lens portions 112a to 116a. The PDs 192 to 196 receive the light incident to the PDs 192 to 196.

Even in the case where the PDs 192 to 196 are provided, the centers of the laser beams emitted from the optical fibers 162 to 166 may tilt with respect to the optical axes of the lens units 112 to 116, so that oblique light beams may be incident to the lens units 112 to 116. Even in this case, according to the microlens 100, the oblique light beams, which have reached the boundary surfaces between the lens units 112 to 116 and the gaps 131b to 131e, may be totally reflected toward the lens units 112 to 116 by the boundary surfaces between the lens units 112 to 116 and the gaps 131b to 131e.

Therefore, according to the microlens 100, even in the case where the PDs 192 to 196 are provided, it is possible to suppress the oblique light beams, which have been incident to the lens units 112 to 116, from leaking to the neighboring lens units. For this reason, according to the microlens 100, it is possible to reduce crosstalk occurring when the oblique light beams, which have been incident to the lens units 112 to 116, leak to the neighboring lens units, and thus it is possible to reduce deterioration in the optical signal caused by the crosstalk. The PDs 191 to 196 are examples of the light sources included in the optical module according to the first embodiment.

In the above description, the example in which the six lens units, that is, the lens units 111 to 116 are provided in the microlens 100 has been described, but the number of lens units is not limited thereto. For example, in the microlens 100, two to five lens units (e.g., only the two lens units 111 and 112) may be provided, or seven or more lens units may be provided.

In the example described above, the adjacent lens units among the lens units 111 to 116 are physically connected to each other by the two connecting units, but the connection is not limited thereto. For example, the adjacent lens units among the lens units 111 to 116 may be physically connected to each other by a single connecting unit. For example, in this case, the lens unit 111 and the lens unit 112 is physically connected to each other only by the connecting unit 121a, and a side below the connecting unit 121a between the lens unit 111 and the lens unit 112 in FIG. 1 is entirely formed as the gap 131a. In this way, it is possible to suppress the oblique light beams, which have been incident to the lens units 111 to 116, from leaking to the neighboring lens units through the connecting units. For this reason, it is possible to reduce crosstalk occurring when the oblique light beams, which have been incident to the lens units 112 to 116, leak to the neighboring lens units, and thus it is possible to reduce deterioration in the optical signal caused by the crosstalk. In addition, in this way, only the connecting units 121a to 121e, which are closer to the light incidence sides than the light emission sides of the lens units 111 to 116, are provided, and as a result, it is possible to suppress the oblique light beams, which have been incident to the lens units 111 to 116, from leaking to the neighboring lens units through the connecting units 121a to 121e. For this reason, it is possible to reduce crosstalk occurring when the oblique light beams, which have been incident to the lens units 112 to 116, leak to the neighboring lens units, and thus it is possible to reduce deterioration in optical signal caused by the crosstalk.

The adjacent lens units among the lens units 111 to 116 may be physically connected to each other by three or more connecting units. For example, in this case, the lens unit 111 and the lens unit 112 are physically connected to each other by the connecting units 121a and 122a and another connecting unit, and the gaps 131a are provided between the respective connecting units. In this way, it is possible to increase strength by which the adjacent lens units among the lens units 111 to 116 are connected to each other.

In the example described above, for example, the connecting units 122a to 122e are provided at the positions close to the convex lens portions 111b to 116b of the lens units 111 to 116 from which the laser beams 171b to 176b are emitted, but the positions of the connecting units 122a to 122e are not limited thereto. For example, similar to the connecting units 121a to 121e, the connecting units 122a to 122e may also be provided at the positions closer to the convex lens portions 111a to 116a of the lens units 111 to 116, from which the laser beams 171a to 176a enter, than the convex lens portions 111b to 116b. Since the connecting units 121a to 121e and 122a to 122e are provided at the positions closer to the light incidence sides than the light emission sides of the lens units 111 to 116, it is possible to suppress the oblique light beams, which have been incident to the lens units 111 to 116, from leaking to the neighboring lens units through the connecting units 121a to 121e and 122a to 122e. For this reason, it is possible to reduce crosstalk occurring when the oblique light beams, which have been incident to the lens units 112 to 116, leak to the neighboring lens units, and thus it is possible to reduce deterioration in optical signal caused by the crosstalk.

### Another Example of Microlens According to First Embodiment

Another example of the microlens 100 according to the first embodiment to be described below is an example in which an optical path changing unit, which changes a traveling direction of the light which has been incident to the microlens 100, is provided in the microlens 100.

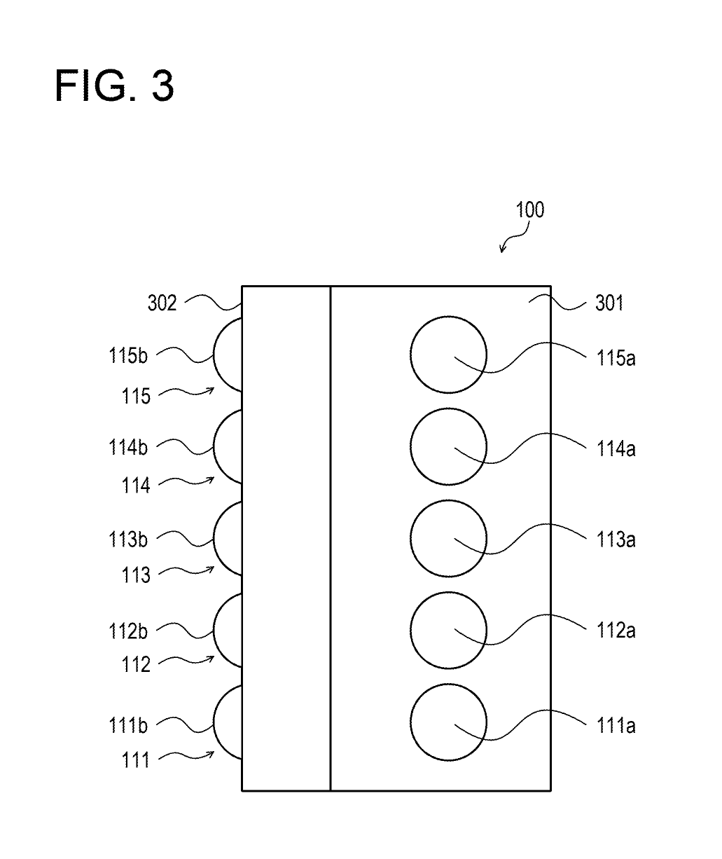

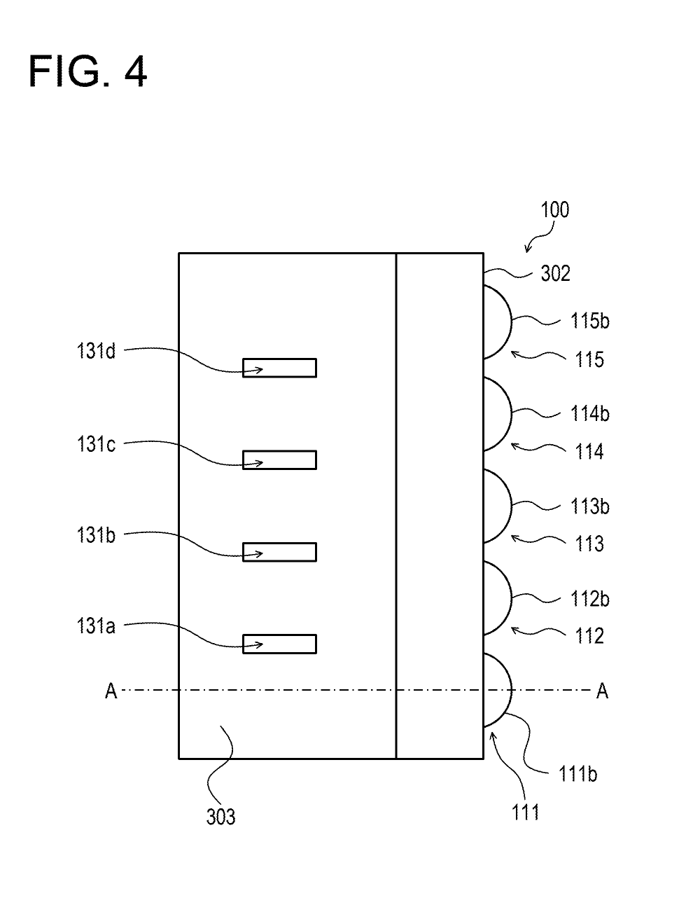

FIG. 3 is a bottom view illustrating another example of the microlens according to the first embodiment. FIG. 4 is a top plan view illustrating another example of the microlens according to the first embodiment. In FIGS. 3 and 4, constituent elements identical to the constituent elements in FIG. 1 are denoted by the same reference numerals, and descriptions thereof will be omitted.

The microlens 100 illustrated in FIGS. 3 and 4 has the lens units 111 to 115. In addition, the microlens 100 is formed in the form of a block having a lower surface 301 (see FIG. 3), a lateral surface 302 (see FIG. 3), and an upper surface 303 (see FIG. 4). The convex lens portions 111a to 115a of the lens units 111 to 115 protrude, for example, from the lower surface 301. That is, the lower surface 301 of the microlens 100 is, for example, provided to face the VCSELs 151 to 155.

The lateral surface 302 is, for example, provided to be perpendicular to the lower surface 301. The convex lens portions 111b to 115b of the lens units 111 to 115 protrude, for example, from the lateral surface 302. That is, the lateral surface 302 of the microlens 100 is, for example, provided to face the optical fibers 161 to 165. In addition, the upper surface 303 is, for example, provided to be inclined at 45 degrees with respect to each of the lower surface 301 and the lateral surface 302.

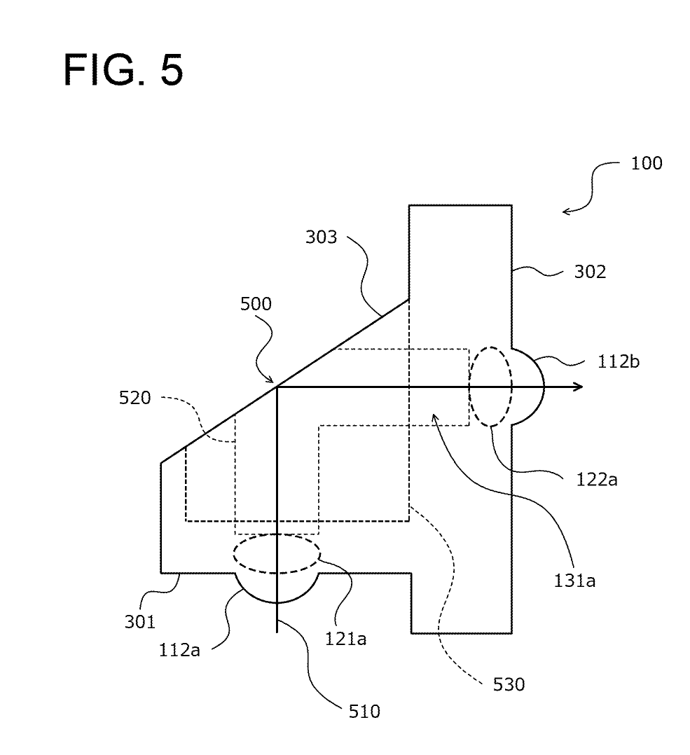

FIG. 5 is a cross-sectional view illustrating another example of the microlens according to the first embodiment. For example, FIG. 5 illustrates an example of a cross section of the microlens 100 illustrated in FIGS. 3 and 4 taken along line A-A in FIG. 4 when viewed in a direction from the bottom to the top in FIG. 4.

As illustrated in FIG. 5, a portion of the upper surface 303, which corresponds to the convex lens portion 111a and the convex lens portion 111b, is an optical path changing unit 500. The optical path changing unit 500 is inclined at 45 degrees with respect to each of an optical axis of the convex lens portion 111a and an optical axis of the convex lens portion 112a. In addition, the outside of the microlens 100 is, for example, air. For this reason, a refractive index outside the microlens 100 is about 1 and smaller than the refractive index of the lens unit 111. Therefore, for example, the laser beam, which has been incident to the lens unit 111 from the convex lens portion 111a, is totally reflected toward the convex lens portion 111b by a boundary surface between the lens unit 111 and the optical path changing unit 500. For this reason, a traveling direction of the laser beam, which has been incident to the lens unit 111 from the convex lens portion 111a, is changed by 90 degrees toward the convex lens portion 111b, as indicated by the arrow 510, and the laser beam is emitted from the convex lens portion 111b.

Although not illustrated, similarly, optical path changing units are also provided by the upper surface 303 at portions of the upper surface 303 which corresponds to the convex lens portions 112a to 115a and the convex lens portions 112b to 115b. Therefore, for example, the laser beams, which have been incident to the lens units 112 to 115 from the convex lens portions 112b to 115b, are totally reflected toward the convex lens portions 112b to 115b by the boundary surfaces between the lens units 112 to 115 and the optical path changing units. For this reason, traveling directions of the laser beams, which have been incident to the lens units 112 to 115 from the convex lens portions 112a to 115a, are changed by 90 degrees toward the convex lens portions 112b to 115b, and the laser beams are emitted from the convex lens portions 112b to 115b.

In the microlens 100 illustrated in FIGS. 3 to 5, the gap 131a between the lens unit 111 and the lens unit 112 is provided such that the laser beam, which has been incident from the convex lens portion 111a, travels along at least a part of the optical path along which the laser beam travels until the laser beam is emitted from the convex lens portion 111b. For example, in the microlens 100 illustrated in FIGS. 3 to 5, the gap 131a between the lens unit 111 and the lens unit 112 is provided at a position indicated by a virtual line 520. In addition, the gap 131a between the lens unit 111 and the lens unit 112 is not limited thereto and may be provided at a position indicated by a virtual line 530, for example, in consideration of ease of forming using a mold.

In the microlens 100 illustrated in FIGS. 3 to 5, the optical axis of the lens unit 111 coincides with the arrow 510, for example. In the microlens 100 illustrated in FIGS. 3 to 5, the gap 131a between the lens unit 111 and the lens unit 112 may be provided in parallel with the optical axis of the lens unit 111 which coincides with the arrow 510.

In the microlens 100 illustrated in FIGS. 3 to 5, the connecting unit 121a between the lens unit 111 and the lens unit 112 is provided from an end of the gap 131a adjacent to the lower surface 301 to the lower surface 301, for example. In addition, in the microlens 100 illustrated in FIGS. 3 to 5, the connecting unit 122a between the lens unit 111 and the lens unit 112 is provided from an end of the gap 131a adjacent to the lateral surface 302 to the lateral surface 302, for example.

Although not illustrated, similarly, the connecting units 121b to 121d and 122b to 122d and the gaps 131b to 131d are provided between the adjacent lens units among the lens units 112 to 115.

According to the microlens 100 illustrated in FIGS. 3 to 5, similar to the microlens 100 illustrated in FIG. 1, the oblique light beams, which have been incident to the lens units 111 to 115, are totally reflected when the oblique light beams reach the gaps 131a to 131d, and as a result, it is possible to suppress the oblique light beams from leaking to the neighboring lens units. For this reason, according to the microlens 100 illustrated in FIGS. 3 to 5, it is possible to reduce crosstalk occurring when the oblique light beams, which have been incident to the lens units 111 to 115, leak to the neighboring lens units, and thus it is possible to reduce deterioration in optical signal caused by the crosstalk.

According to the microlens 100 illustrated in FIGS. 3 to 5, the traveling direction of the light, which has been incident to the microlens 100, may be changed by 90 degrees. Therefore, for example, the light, which has been emitted from the VCSEL perpendicularly to the board, is changed to be parallel to the board, so that the light may be incident to the optical fiber provided in parallel with the board.

### Optical Module According to First Embodiment

FIG. 6 is a cross-sectional view illustrating an example of the optical module according to the first embodiment. In FIG. 6, constituent elements identical to the constituent elements in FIGS. 3 to 5 are denoted by the same reference numerals, and descriptions thereof will be omitted. An optical module 600 according to the first embodiment illustrated in FIG. 6 is an example of the optical module having the microlens 100 illustrated in FIGS. 3 to 5. For example, the optical module 600 is an optical module that converts an electrical signal, which has been inputted from a server or the like, into an optical signal and outputs the converted optical signal from the optical fibers 161 to 165.

As illustrated in FIG. 6, the optical module 600 has, for example, a board 610, a lens block 620, and an exterior member 630. The board 610 is electrically connected to a motherboard 650 of a server or the like through a connector 651 of the motherboard 650. Therefore, an electrical signal is inputted to the optical module 600 from the motherboard 650. In addition, for example, the VCSEL 151 and a drive circuit 611 are provided on the board 610.

The drive circuit 611 creates a driving signal for the VCSEL 151 based on the electrical signal inputted to the board 610 and outputs the created driving signal to the VCSEL 151. The VCSEL 151 outputs an optical signal by operating based on the driving signal inputted from the drive circuit 611, thereby converting the electrical signal, which has been inputted to the board 610, into the optical signal.

Although not illustrated, similarly, the VCSELs 152 to 155 are also provided on the board 610, for example. Further, the drive circuit 611 creates driving signals for the VCSELs 152 to 155 based on the electrical signals inputted to the board 610 and outputs the created driving signals to the VCSELs 152 to 155. The VCSELs 152 to 155 output optical signals by operating based on the driving signals inputted from the drive circuit 611, thereby converting the electrical signals, which have been inputted to the board 610, into the optical signals.

A non-illustrated optical modulator may be provided on the board 610. In this case, the VCSELs 151 to 155 emit continuous light. In addition, for example, the drive circuit 611 creates a driving signal for the optical modulator based on the electrical signal inputted to the board 610 and outputs the created driving signal to the optical modulator. The optical modulator operates based on the driving signal inputted from the drive circuit 611 and modulates the continuous light emitted from the VCSELs 151 to 155, thereby converting the electrical signal, which has been inputted to the board 610, into the optical signal.

As illustrated in FIG. 6, the drive circuit 611 may be thermally connected to the exterior member 630 through a thermal block 612 made of copper or the like. Therefore, it is possible to decrease a temperature of the drive circuit 611 by removing heat of the drive circuit 611 to the exterior member 630.

The lens block 620 has the microlens 100, and a support unit 621 which supports the microlens 100. For example, the lens block 620 is implemented by integrally forming the microlens 100 and the support unit 621 and fixed to the board 610 as the support unit 621 is attached to the board 610.

The optical fiber (e.g., the optical fiber 161) inserted into the optical module 600 is fixed to the lens block 620, for example, by an MT ferrule 622 and an MT clip 623. The lens block 620 and the periphery of the lens block 620 will be described below with reference to FIG. 7. MT stands for Mechanically Transferable.

The exterior member 630 is provided to surround the board 610 and the lens block 620. An opening 631 is provided in the exterior member 630. The optical fiber 161 is inserted into the exterior member 630 from the outside through the opening 631. In addition, although not illustrated, for example, similar to the optical fiber 161, the optical fibers 162 to 165 are also inserted into the exterior member 630 from the outside through the opening 631.

As illustrated in FIG. 6, the exterior member 630 may be thermally connected to a heat sink 641 and a cooling unit 642. For example, the cooling unit 642 includes a heat dissipation plate which is provided such that a lower surface thereof is in contact with the heat sink 641, and a heat pipe which is provided to be in contact with an upper surface of the heat dissipation plate. Therefore, heat of the exterior member 630 is removed to the heat sink 641 and the cooling unit 642, so that a temperature of or in the exterior member 630 may be decreased.

FIG. 7 is a cross-sectional view illustrating an example of a part of the optical module according to the first embodiment. For example, FIG. 7 is an enlarged view illustrating the lens block 620 and the periphery of the lens block 620 illustrated in FIG. 6.

As illustrated in FIG. 7, in the optical module 600, the microlens 100 is, for example, fixed to the board 610 in a state where the convex lens portion 111a and the VCSEL 151 face each other. Further, in the optical module 600, the optical fiber 161 is fixed to the lens block 620 by the MT ferrule 622 and the MT clip 623 in the state where the end of the optical fiber 161 faces the convex lens portion 111b.

Therefore, in the optical module 600, as indicated by the arrow 700, the laser beam emitted from the VCSEL 151 is incident to the microlens 100 from the convex lens portion 111a. Further, the traveling direction of the laser beam, which has been incident from the convex lens portion 111a, is changed by 90 degrees toward the convex lens portion 111b, so that the laser beam is emitted from the convex lens portion 111b and then incident to the optical fiber 161. The laser beam, which has been incident to the optical fiber 161, is transmitted to the corresponding device of the optical module 600 through the optical fiber 161.

Although not illustrated, similarly, in the optical module 600, the microlens 100 is, for example, fixed to the board 610 in a state where the convex lens portions 112a to 115a face the VCSELs 152 to 155, respectively. Further, in the optical module 600, the optical fibers 162 to 165 are fixed to the lens block 620 by the MT ferrule 622 and the MT clip 623 in the state where the ends of the optical fibers 162 to 165 face the convex lens portions 112b to 115b.

Therefore, in the optical module 600, the laser beams emitted from the VCSELs 152 to 155 are incident to the microlens 100 from the convex lens portions 112a to 115a. Further, the traveling directions of the laser beams, which have been incident from the convex lens portions 112a to 115a, are changed by 90 degrees toward the convex lens portions 112b to 115b, so that the laser beams are emitted from the convex lens portions 112b to 115b and then incident to the optical fibers 162 to 165. The laser beams, which have been incident to the optical fibers 162 to 165, are transmitted to the corresponding device of the optical module 600 through the optical fibers 162 to 165.

In the optical module 600, for example, the PDs 191 to 195 may be provided on the board 610 instead of the VCSELs 151 to 155. For example, in the case where the PDs 191 to 195 are provided, the laser beams are incident to the optical fibers 161 to 165 from the corresponding device of the optical module 600. Further, the optical fibers 161 to 165 output the laser beams, which have been incident from the corresponding device of the optical module 600, to the convex lens portions 111b to 115b, respectively. The traveling directions of the laser beams, which have been incident from the convex lens portions 111b to 115b, are changed by 90 degrees, so that the laser beams are emitted from the convex lens portions 111a to 115a. Further, the PDs 191 to 195 receive the laser beams emitted from the convex lens portions 111a to 115a, respectively. The drive circuit 611 converts the optical signals received by the PDs 191 to 195 into electrical signals and outputs the converted electrical signals to the motherboard 650 through the connector 651, for example.

The corresponding device of the optical module 600 having the VCSELs 151 to 155 may be changed to the optical module 600 that has the PDs 191 to 195 instead of the VCSELs 151 to 155. In addition, the configuration of the optical module 600 is not limited thereto, and for example, the optical module 600 may be an optical transceiver that has all of the VCSELs 151 to 155 and the PDs 191 to 195 and transmits and receives optical signals.

In this way, the optical module 600 according to the first embodiment has, between the multiple lens units in the microlens 100, the connecting units that connect the lens units, and the gaps where the lens units are not connected to one another. Therefore, the multiple lens units are fixed to one another by the connecting units that connect the lens units, and the respective optical axes of the multiple lens units may be aligned without individually positioning or adjusting the multiple lens units. In addition, the oblique light beam, which has been incident to the lens unit, is totally reflected by the gap where the lens units are not connected to each other, and as a result, it is possible to suppress the oblique light beam from leaking to the neighboring lens unit.

### Second Embodiment

Parts of a second embodiment, which are different from the parts of the first embodiment, will be described. The second embodiment to be described below is, for example, an example in which a light shielding plate, which shields the laser beams emitted from the VCSELs 151 to 156 so as not to be incident to the neighboring lens unit, is provided.

### Example of Microlens According to Second Embodiment

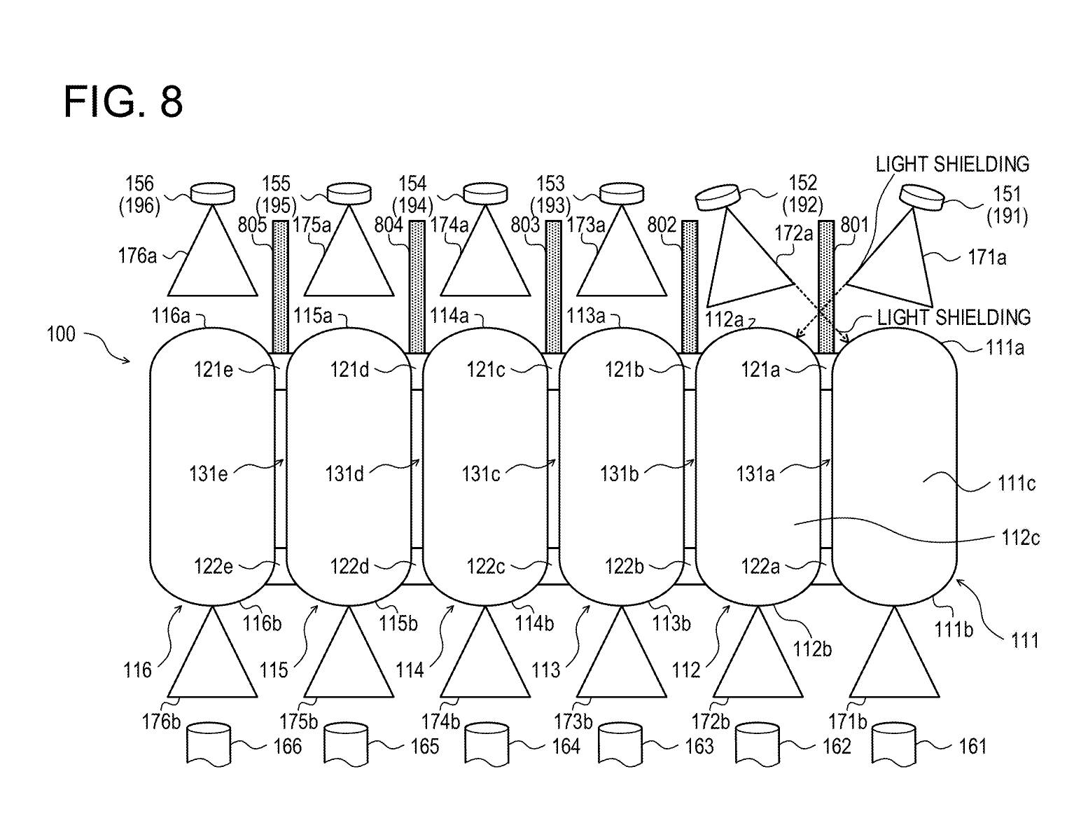

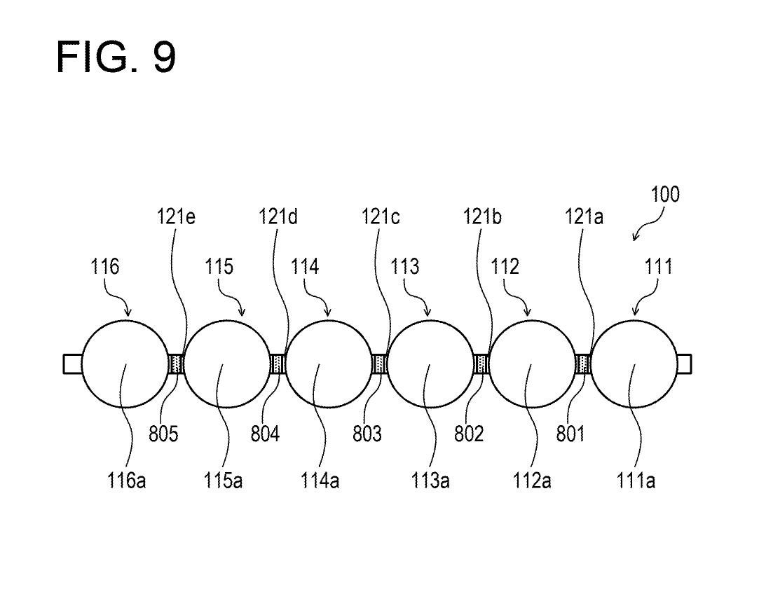

FIG. 8 is a front view illustrating an example of the microlens according to the second embodiment. FIG. 9 is a top plan view illustrating an example of the microlens according to the second embodiment. In FIG. 8, constituent elements identical to the constituent elements in FIG. 1 are denoted by the same reference numerals, and descriptions thereof will be omitted. In addition, in FIG. 9, constituent elements identical to the constituent elements in FIG. 2 are denoted by the same reference numerals, and descriptions thereof will be omitted.

In the microlens 100 according to the second embodiment illustrated in FIGS. 8 and 9, light shielding plates 801 to 805 are provided between the adjacent lens units among the lens units 111 to 116. For example, the light shielding plate 801 is provided between the convex lens portion 111a and the convex lens portion 112a and shields the laser beam 172a emitted from the VCSEL 152 so as not to be incident to the neighboring convex lens portion 111a. In addition, the light shielding plate 801 may shield the laser beam 171a emitted from the VCSEL 151 so as not to be incident to the neighboring convex lens portion 112a.

For example, the light shielding plate 801 is provided at a portion of the connecting unit 121a adjacent to the VCSELs 151 and 152 between the lens unit 111 and the lens unit 112. In addition, the light shielding plate 801 is provided to protrude further toward the VCSELs 151 and 152 than the convex lens portions 111a and 112a. In addition, a material that reflects light and does not transmit light may be deposited or applied onto portions of the light shielding plate 801 adjacent to the convex lens portions 111a and 112a. An example of the material that reflects light and does not transmit light is gold. With the configuration, the light shielding plate 801 may shield the laser beam 172a emitted from the VCSEL 152 so as not to be incident to the convex lens portion 111a, and the light shielding plate 801 may shield the laser beam 171a emitted from the VCSEL 151 so as not to be incident to the convex lens portion 112a.

For this reason, the light shielding plate 801 may reduce crosstalk occurring when the laser beam 172a emitted from the VCSEL 152 is incident to the convex lens portion 111a, thereby reducing deterioration in optical signal caused by the crosstalk. In addition, the light shielding plate 801 may reduce crosstalk occurring when the laser beam 171a emitted from the VCSEL 151 is incident to the convex lens portion 112a, thereby reducing deterioration in optical signal caused by the crosstalk.

Similarly, the light shielding plates 802 to 805 are provided at portions of the connecting units 121b to 121e adjacent to the VCSELs 152 to 156 between the adjacent convex lens portions among the convex lens portions 112a to 116a. In addition, the light shielding plates 802 to 805 are provided to protrude further toward the VCSELs 152 and 156 than the convex lens portions 112a and 116a. In addition, a material that reflects light and does not transmit light may be deposited or applied onto portions of the light shielding plates 802 to 805 adjacent to the convex lens portions 112a and 116a. With the configuration, the light shielding plates 802 to 805 may shield the laser beams 172a to 176a emitted from the VCSELs 152 to 156 so as not to be incident to the neighboring convex lens portions. For this reason, the light shielding plates 802 to 805 may reduce crosstalk occurring when the laser beams 172a to 176a emitted from the VCSELs 152 to 156 are incident to the neighboring convex lens portions, thereby reducing deterioration in the optical signal caused by crosstalk.

For example, the light shielding plate 801 reflects the laser beam, which has reached the light shielding plate 801 among the laser beams 171a emitted from the VCSEL 151, toward the convex lens portion 111a, thereby allowing the laser beam to be incident to the convex lens portion 111a. For this reason, the light shielding plate 801 may suppress deterioration in intensity of the laser beam incident to the convex lens portion 111a.

Similarly, for example, the light shielding plates 802 to 805 may reflect the laser beams, which have reached the light shielding plates 802 to 805 among the laser beams 172a to 176a emitted from the VCSELs 152 to 156, toward the convex lens portions 112a to 116a. Therefore, the light shielding plates 802 to 805 may allow the laser beams, which have reached the light shielding plates 802 to 805 among the laser beams 172a to 176a emitted from the VCSELs 152 to 156, to be incident to the convex lens portions 112a to 116a. For this reason, the light shielding plates 802 to 805 may suppress deterioration in the intensity of the laser beams incident to the convex lens portions 112a to 116a.

For example, in the microlens 100 according to the second embodiment, the portions of the lens units 111 to 116, the connecting units 121a to 121e and 122a to 122e, and the light shielding plates 801 to 805 are integrally formed by using a mold and by using resin or the like. Further, the microlens 100 according to the second embodiment may be implemented by integrally forming the lens units 111 to 116, the connecting units 121a to 121e and 122a to 122e, and the light shielding plates 801 to 805, and then depositing gold on the portions of the light shielding plates 801 to 805. Therefore, it is possible to easily form the microlens 100 having the lens units 111 to 116 in which the directions of the optical axes and the pitch are constant, and the gaps 131a to 131e and the light shielding plates 801 to 805.

In the example described above, the light shielding plates 801 to 805 are configured to reflect light, but the light shielding plates 801 to 805 are not limited thereto. For example, a material, which absorbs light, is deposited or applied onto the portions of the light shielding plates 801 to 805 adjacent to the convex lens portions 111a to 116a, so that the light shielding plates 801 to 805 may absorb light.

As described above, according to the microlens 100 illustrated in FIGS. 8 and 9, similar to the microlens 100 according to the first embodiment, the oblique light beams, which have been incident to the lens units 111 to 116, are totally reflected when the oblique light beams reach the gaps 131a to 131e. Therefore, according to the microlens 100 illustrated in FIGS. 8 and 9, it is possible to suppress the oblique light beams, which have been incident to the lens units 111 to 116, from leaking to the neighboring lens units. For this reason, according to the microlens 100 illustrated in FIGS. 8 and 9, it is possible to reduce crosstalk occurring when the oblique light beams, which have been incident to the lens units 111 to 116, leak to the neighboring lens units, and thus it is possible to reduce deterioration in the optical signal caused by crosstalk.

According to the microlens 100 illustrated in FIGS. 8 and 9, the laser beams 171a to 176a emitted from the VCSELs 151 to 156 may be shielded by the light shielding plates 801 to 805 so as not to be incident to the neighboring lens units. For this reason, according to the microlens 100 illustrated in FIGS. 8 and 9, it is possible to reduce crosstalk occurring when the laser beams 171a to 176a emitted from the VCSELs 151 to 156 are incident to the neighboring lens units, and thus it is possible to reduce deterioration in optical signal caused by the crosstalk.

In the example described above, the VCSELs 151 to 156 are provided, but the operations of the light shielding plates 801 to 805 are not limited thereto. For example, as illustrated in FIG. 8, the PD 191 may be provided instead of the VCSEL 151. In the case where the PD 191 is provided, the light shielding plate 801 may shield the laser beam, which has been emitted from the convex lens portion 112a, so as not to be incident to the PD 191 For this reason, according to the microlens 100 illustrated in FIGS. 8 and 9, it is possible to reduce crosstalk occurring when the laser beam, which has been emitted from the convex lens portion 112a, is incident to the PD 191, and thus it is possible to reduce deterioration in optical signal caused by the crosstalk.

Similarly, in the microlens 100 illustrated in FIGS. 8 and 9, the PDs 192 to 196 may be provided instead of the VCSELs 152 to 156. In the case where the PDs 192 to 196 are provided, the light shielding plates 802 to 805 may shield the laser beams, which have been emitted from the convex lens portions 112a to 116a, so as not to be incident to the neighboring PDs. For this reason, according to the microlens 100 illustrated in FIGS. 8 and 9, it is possible to reduce crosstalk occurring when the laser beams, which have been emitted from the convex lens portions 112a to 116a, are incident to the neighboring PDs, and thus it is possible to reduce deterioration in optical signal caused by the crosstalk.

### Another Example of Microlens According to Second Embodiment

Another example of the microlens 100 according to the second embodiment to be described below is an example in which the optical path changing unit 500, which changes the traveling direction of the light which has been incident to the microlens 100, is provided in the microlens 100 according to the second embodiment.

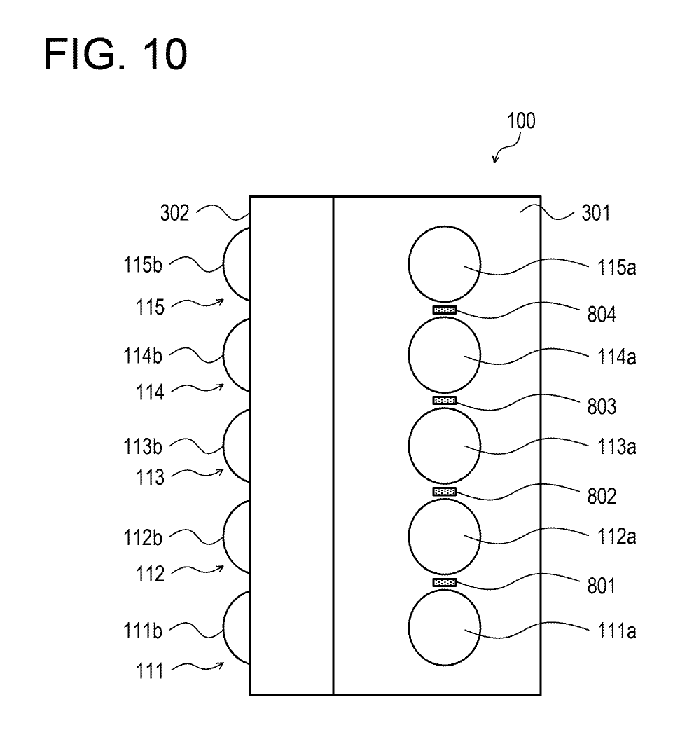

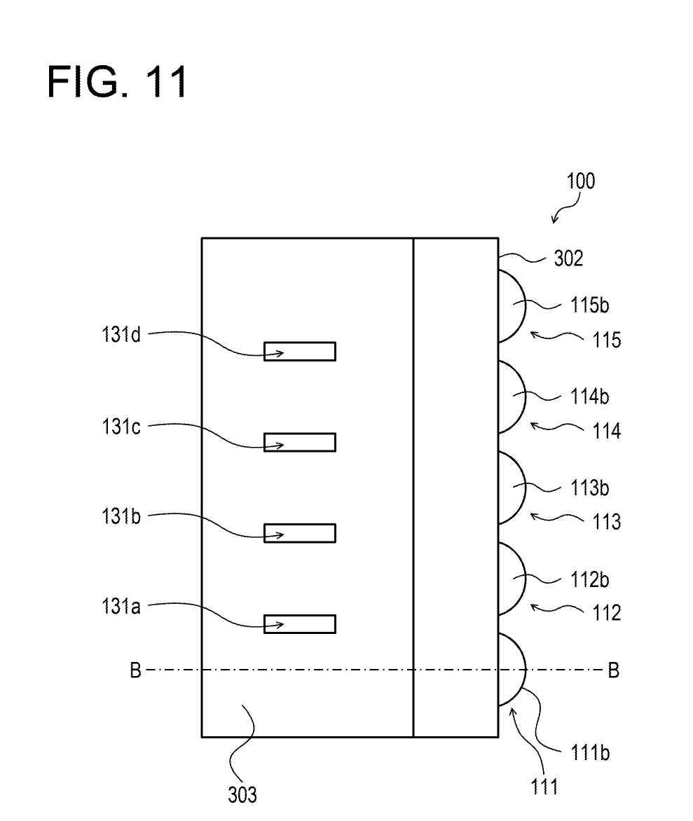

FIG. 10 is a bottom view illustrating another example of the microlens according to the second embodiment. FIG. 11 is a top plan view illustrating another example of the microlens according to the second embodiment. In FIG. 10, constituent elements identical to the constituent elements in FIGS. 3 and 8 are denoted by the same reference numerals, and descriptions thereof will be omitted. In FIG. 11, constituent elements identical to the constituent elements in FIGS. 4 and 8 are denoted by the same reference numerals, and descriptions thereof will be omitted.

In the microlens 100 illustrated in FIGS. 10 and 11, for example, the light shielding plates 801 to 804 are provided between the adjacent convex lens portions among the convex lens portions 111a to 115a on the lower surface 301 and provided to protrude from the lower surface 301.

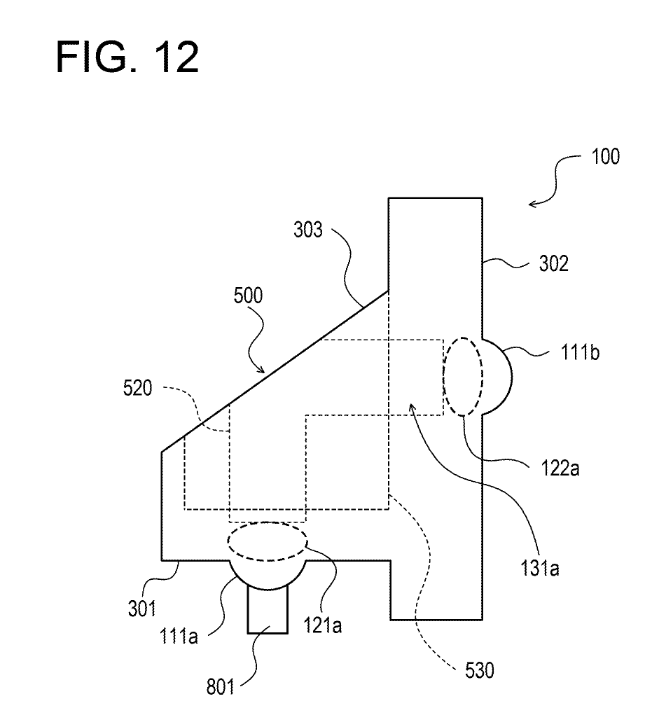

FIG. 12 is a cross-sectional view illustrating another example of the microlens according to the second embodiment. For example, FIG. 12 illustrates an example of a cross section of the microlens 100 illustrated in FIGS. 10 and 11 taken along line B-B in FIG. 11 when viewed in a direction from the bottom to the top in FIG. 11. As illustrated in FIG. 12, for example, the light shielding plate 801 between the convex lens portion 111a and the convex lens portion 112a is provided to further protrude from the lower surface 301 than the convex lens portion 111a. In addition, although not illustrated, similarly, the light shielding plates 802 to 804 are provided to further protrude from the lower surface 301 than the convex lens portions 112a to 115a.

According to the microlens 100 illustrated in FIGS. 10 to 12, similar to the microlens 100 illustrated in FIG. 8, the oblique light beams, which have been incident to the lens units 111 to 115, are totally reflected when the oblique light beams reach the gaps 131a to 131d, and as a result, it is possible to suppress the oblique light beams from leaking to the neighboring lens units. For this reason, according to the microlens 100 illustrated in FIGS. 10 to 12, it is possible to reduce crosstalk occurring when the oblique light beams, which have been incident to the lens units 111 to 115, leak to the neighboring lens units, and thus it is possible to reduce deterioration in the optical signal caused by crosstalk. In addition, according to the microlens 100 illustrated in FIGS. 10 to 12, the traveling direction of the light, which has been incident to the microlens 100, may be changed by 90 degrees.

According to the microlens 100 illustrated in FIGS. 10 to 12, the laser beams emitted from the VCSELs 151 to 155 may be shielded by the light shielding plates 801 to 804 so as not to be incident to the neighboring lens units. For this reason, according to the microlens 100 illustrated in FIGS. 10 to 12, it is possible to reduce crosstalk occurring when the laser beams emitted from the VCSELs 151 to 155 are incident to the neighboring lens units, and thus it is possible to reduce deterioration in optical signal caused by the crosstalk.

According to the microlens 100 illustrated in FIGS. 10 to 12, the laser beams, which have been emitted from the lens units 111 to 115, may be shielded by the light shielding plates 801 to 804 so as not to be incident to the neighboring PDs. For this reason, according to the microlens 100 illustrated in FIGS. 10 to 12, it is possible to reduce crosstalk occurring when the laser beams, which have been emitted from the lens units 111 to 115, are incident to the neighboring PDs, and thus it is possible to reduce deterioration in optical signal caused by the crosstalk.

### Example of Optical Module According to Second Embodiment

For example, the optical module 600 according to the second embodiment is made by substituting the microlens 100 of the optical module 600 according to the first embodiment illustrated in FIG. 6 with the microlens 100 illustrated in FIGS. 10 to 12.

For this reason, according to the optical module 600 according to the second embodiment, similar to the microlens 100 illustrated in FIGS. 10 to 12, the oblique light beams, which have been incident to the lens units 111 to 115, are totally reflected when the oblique light beams reach the gaps 131a to 131d. Therefore, according to the optical module 600 according to the second embodiment, it is possible to suppress the oblique light beams, which have been incident to the lens units 111 to 115, from leaking to the neighboring lens units. For this reason, according to the optical module 600 according to the second embodiment, it is possible to reduce crosstalk occurring when the oblique light beams, which have been incident to the lens units 111 to 115, leak to the neighboring lens units, and thus it is possible to reduce deterioration in the optical signal caused by crosstalk.

According to the optical module 600 according to the second embodiment, similar to the microlens 100 illustrated in FIGS. 10 to 12, the laser beams emitted from the VCSELs 151 to 155 may be shielded by the light shielding plates 801 to 804 so as not to be incident to the neighboring lens units. For this reason, according to the optical module 600 according to the second embodiment, it is possible to reduce crosstalk occurring when the laser beams emitted from the VCSELs 151 to 155 are incident to the neighboring lens unit, and thus it is possible to reduce deterioration in optical signal caused by the crosstalk.

According to the optical module 600 according to the second embodiment, the laser beams, which have been emitted from the lens units 111 to 115, may be shielded by the light shielding plates 801 to 804 so as not to be incident to the neighboring PDs. For this reason, according to the optical module 600 according to the second embodiment, it is possible to reduce crosstalk occurring when the laser beams, which have been emitted from the lens units 111 to 115, are incident to the neighboring PDs, and thus it is possible to reduce deterioration in optical signal caused by the crosstalk.

In this way, according to the optical module 600 according to the second embodiment, similar to the optical module 600 according to the first embodiment, it is possible to suppress the oblique light beam, which has been incident to the lens unit, from leaking to the neighboring lens unit. In addition, according to the optical module 600 according to the second embodiment, the light shielding plates are provided between the respective lens units at the light incidence side of the microlens 100, and as a result, it is possible to suppress the oblique light beam, before being incident to the lens unit, from being incident to the neighboring lens unit. Alternatively, according to the optical module 600 according to the second embodiment, the light shielding plates are provided between the respective lens units at the light emission side of the microlens 100, and as a result, it is possible to suppress the oblique light beam, which has been emitted from the lens unit to the PD, from being incident to the neighboring PD. For this reason, according to the optical module 600 according to the second embodiment, it is possible to reduce deterioration in optical signal.

### Third Embodiment

Parts of a third embodiment, which are different from the parts of the first embodiment, will be described. The third embodiment to be described below is, for example, an example in which a light shielding film, which shields the laser beams emitted from the VCSELs 151 to 156 so as not to be incident to the neighboring lens unit, is provided.

### Example of Microlens According to Third Embodiment

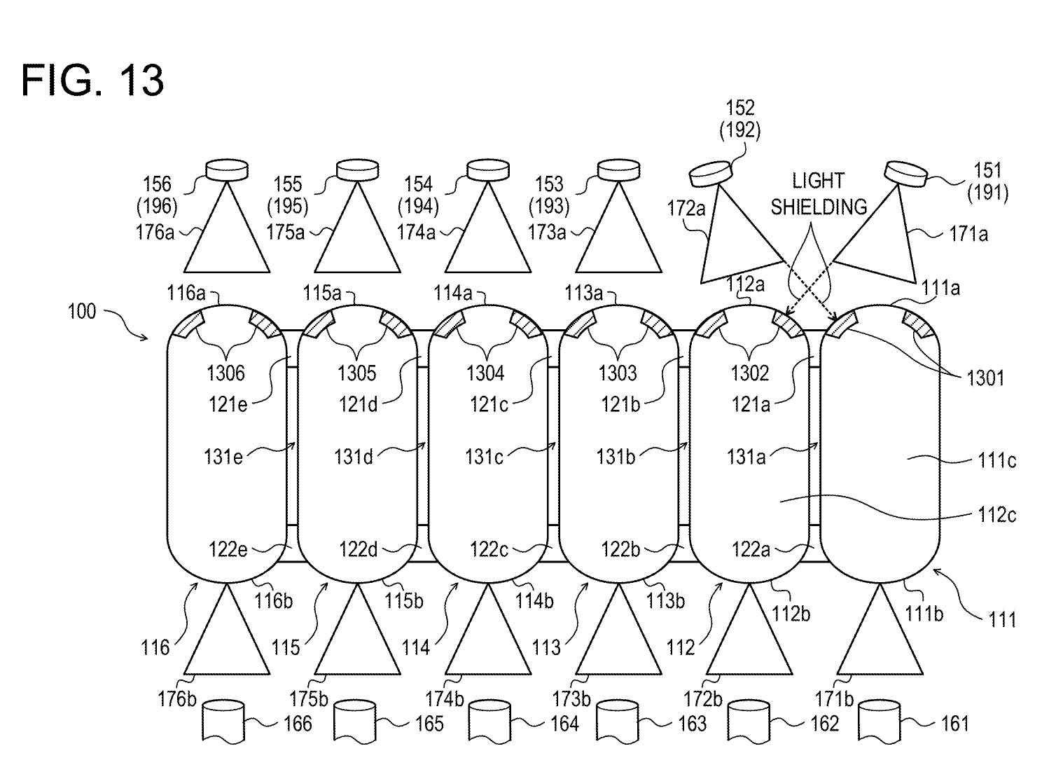

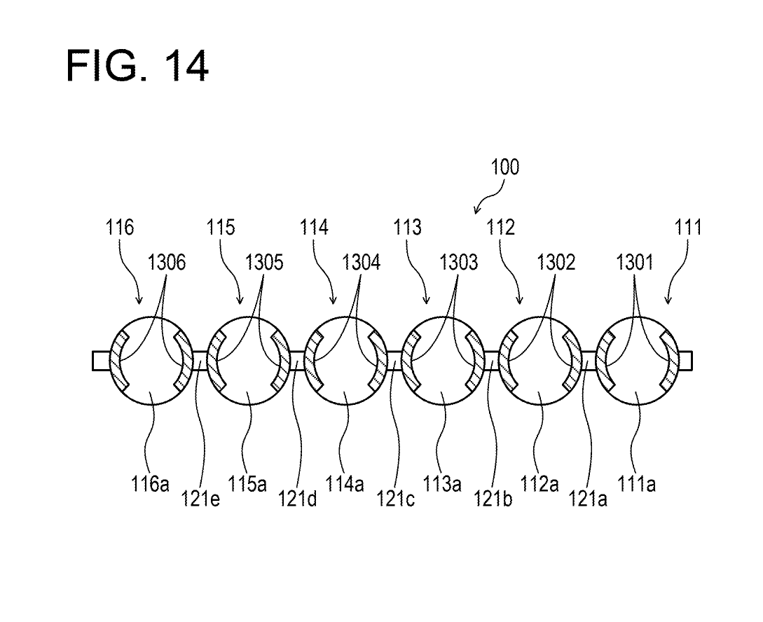

FIG. 13 is a front view illustrating an example of a microlens according to the third embodiment. FIG. 14 is a top plan view illustrating an example of the microlens according to the third embodiment. In FIG. 13, constituent elements identical to the constituent elements in FIG. 1 are denoted by the same reference numerals, and descriptions thereof will be omitted. In addition, in FIG. 14, constituent elements identical to the constituent elements in FIG. 2 are denoted by the same reference numerals, and descriptions thereof will be omitted.

In the microlens 100 according to the third embodiment illustrated in FIGS. 13 and 14, light shielding films 1301 to 1306 are provided on the lens units 111 to 116. For example, the light shielding films 1301 are provided on the convex lens portion 111a and shield the laser beam 172a emitted from the VCSEL 152 so as not to be incident to the convex lens portion 111a.

For example, the light shielding film 1301 is provided by depositing or applying a material that reflects light and does not transmit light, such as gold, on a part of a surface of the convex lens portion 111a which is adjacent to the neighboring convex lens portion 112a. Therefore, the light shielding film 1301 may shield the laser beam 172a emitted from the VCSEL 152 so as not to be incident to the convex lens portion 111a. Therefore, the light shielding film 1301 may reduce crosstalk occurring when the laser beam 172a emitted from the VCSEL 152 is incident to the convex lens portion 111a, thereby reducing deterioration in optical signal caused by the crosstalk.

Similarly, the light shielding films 1302 are provided on the convex lens portion 112a and shield the laser beam 171a emitted from the VCSEL 151 so that the laser beam 171a does not enter the convex lens portion 112a. In addition, the light shielding film 1302 may shield the laser beam 173a emitted from the VCSEL 153 opposite to the VCSEL 151 so as not to be incident to the convex lens portion 112a.

For example, the light shielding film 1302 is provided by depositing or applying a material that reflects light and does not transmit light, on a part of a surface of the convex lens portion 112a adjacent to the convex lens portion 111a and on a part of the convex lens portion 113a. Therefore, the light shielding film 1302 may shield the laser beam 171a emitted from the VCSEL 151 so as not to be incident to the convex lens portion 112a. In addition, therefore, the light shielding film 1302 may shield the laser beam 173a emitted from the VCSEL 153 so as not to be incident to the convex lens portion 112a. Therefore, the light shielding film 1302 may reduce crosstalk corresponding when the laser beam 171a emitted from the VCSEL 151 or the laser beam 173a emitted from the VCSEL 153 is incident to the convex lens portion 112a, thereby reducing deterioration in the optical signal caused by crosstalk.

Similarly, the light shielding films 1303 to 1306 are provided on the convex lens portions 113a to 116a and shield the laser beams emitted from the neighboring VCSELs so as not to be incident to the convex lens portions 113a to 116a. In addition, for example, each of the light shielding films 1303 to 1306 is provided by depositing or applying a material that reflects light and does not transmit light, on a part of a surface of each of the convex lens portions 113a to 116a adjacent to the convex lens portion. Therefore, the light shielding films 1303 to 1306 may shield the laser beams emitted from the neighboring VCSELs so that the laser beams do not are incident to the convex lens portions 113a to 116a. Therefore, the light shielding films 1303 to 1306 may reduce crosstalk occurring when the laser beams emitted from the neighboring VCSELs are incident to the convex lens portions 113a to 116a, thereby reducing deterioration in optical signal caused by the crosstalk.

For example, in the microlens 100 according to the third embodiment, the lens units 111 to 116 and the connecting units 121a to 121e and 122a to 122e are integrally formed by using a mold and by using resin or the like. Further, the microlens 100 according to the third embodiment may be implemented by integrally forming the lens units 111 to 116 and the connecting units 121a to 121e and 122a to 122e and then depositing gold on the portions of the light shielding films 1301 to 1306. Therefore, it is possible to easily form the microlens 100 having the lens units 111 to 116 in which the directions of the optical axes and the pitch are constant, and the gaps 131a to 131e and the light shielding films 1301 to 1306.

In the example described above, the light shielding films 1301 to 1306 are configured to reflect light, but the operations of the light shielding films 1301 to 1306 are not limited thereto. For example, a material, which absorbs light, may be deposited on the portions of the convex lens portions 111a to 116a, which are configured as the light shielding films 1301 to 1306, so that the light shielding films 1301 to 1306 may absorb light.

As described above, according to the microlens 100 illustrated in FIGS. 13 and 14, similar to the microlens 100 according to the first embodiment, the oblique light beams, which have been incident to the lens units 111 to 116, are totally reflected when the oblique light beams reach the gaps 131a to 131e. Therefore, according to the microlens 100 illustrated in FIGS. 13 and 14, it is possible to suppress the oblique light beams, which have been incident to the lens units 111 to 116, from leaking to the neighboring lens units. For this reason, according to the microlens 100 illustrated in FIGS. 13 and 14, it is possible to reduce crosstalk occurring when the oblique light beams, which have been incident to the lens units 111 to 116, leak to the neighboring lens units, and thus it is possible to reduce deterioration in optical signal caused by the crosstalk.

According to the microlens 100 illustrated in FIGS. 13 and 14, the laser beams emitted from the VCSELs 151 to 156 may be shielded by the light shielding films 1301 to 1305 so as not to be incident to the neighboring lens units 111 to 116. For this reason, according to the microlens 100 illustrated in FIGS. 13 and 14, it is possible to reduce crosstalk occurring when the laser beams emitted from the VCSELs 151 to 155 are incident to the neighboring lens units 111 to 116, and thus it is possible to reduce deterioration in the optical signal caused by crosstalk.

In the example described above, the VCSELs 151 to 156 are provided, but the configuration is not limited thereto. For example, as illustrated in FIG. 13, the PD 191 may be provided instead of the VCSEL 151. In the case where the PD 191 is provided, the light shielding film 1302 may shield the laser beam, which has been emitted from the convex lens portion 112a, so as not to be incident to the neighboring PD 191. For this reason, according to the microlens 100 illustrated in FIGS. 13 and 14, it is possible to reduce crosstalk occurring when the laser beam, which has been emitted from the convex lens portion 112a, is incident to the PD 191, and thus it is possible to reduce deterioration in the optical signal caused by crosstalk.

Similarly, in the microlens 100 illustrated in FIGS. 13 and 14, the PDs 192 to 196 may be provided instead of the VCSELs 152 to 156. In the case where the PDs 192 to 196 are provided, the light shielding films 1302 to 1306 may shield the laser beams, which have been emitted from the convex lens portions 112a to 116a, so as not to be incident to the neighboring PDs. For this reason, according to the microlens 100 illustrated in FIGS. 13 and 14, it is possible to reduce crosstalk occurring when the laser beams, which have been emitted from the convex lens portions 112a to 116a, are incident to the neighboring PDs, and thus it is possible to reduce deterioration in the optical signal caused by crosstalk.

### Another Example of Microlens According to Third Embodiment

Another example of the microlens 100 according to the third embodiment to be described below is an example in which the optical path changing unit 500, which changes the traveling direction of the light which has been incident to the microlens 100, is provided in the microlens 100 according to the third embodiment. Hereinafter, parts different from the parts of the microlens 100 illustrated in FIGS. 3 to 5 will be described.

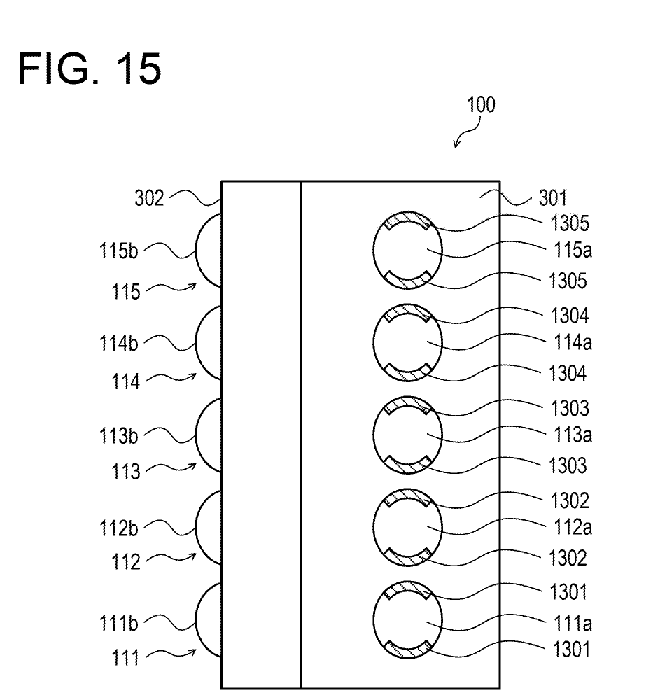

FIG. 15 is a bottom view illustrating another example of the microlens according to the third embodiment. In FIG. 15, constituent elements identical to the constituent elements in FIGS. 3 and 13 are denoted by the same reference numerals, and descriptions thereof will be omitted. In the microlens 100 according to the third embodiment illustrated in FIG. 15, for example, the light shielding films 1301 to 1305 are provided on the convex lens portions 111a to 115a on the lower surface 301. For example, the microlens 100 illustrated in FIG. 15 is identical to the microlens 100 illustrated in FIGS. 3 to 5 except that the light shielding films 1301 to 1305 are provided on the convex lens portions 111a to 115a.

According to the microlens 100 illustrated in FIG. 15, similar to the microlens 100 illustrated in FIG. 13, the oblique light beams, which have been incident to the lens units 111 to 115, are totally reflected when the oblique light beams reach the gaps 131a to 131d, and as a result, it is possible to suppress the oblique light beams from leaking to the neighboring lens units. For this reason, according to the microlens 100 illustrated in FIG. 15, it is possible to reduce crosstalk occurring when the oblique light beams, which have been incident to the lens units 111 to 115, leak to the neighboring lens units, and thus it is possible to reduce deterioration in the optical signal caused by crosstalk.

According to the microlens 100 illustrated in FIG. 15, similar to the microlens 100 illustrated in FIG. 13, the laser beams emitted from the VCSELs 151 to 155 may be shielded by the light shielding films 1301 to 1305 so as not to be incident to the neighboring lens units. For this reason, according to the microlens 100 illustrated in FIG. 15, it is possible to reduce crosstalk occurring when the laser beams emitted from the VCSELs 151 to 155 are incident to the neighboring lens units, and thus it is possible to reduce deterioration in optical signal caused by the crosstalk.

According to the microlens 100 illustrated in FIG. 15, similar to the microlens 100 illustrated in FIG. 13, the laser beams, which have been emitted from the convex lens portions 111a to 115a, may be shielded by the light shielding films 1301 to 1305 so as not to be incident to the neighboring PDs. For this reason, according to the microlens 100 illustrated in FIG. 15, it is possible to reduce crosstalk occurring when the laser beams, which have been emitted from the convex lens portions 111a to 115a, are incident to the neighboring PDs, and thus it is possible to reduce deterioration in the optical signal caused by crosstalk.

### Example of Optical Module According to Third Embodiment

For example, the optical module 600 according to the third embodiment is made by substituting the microlens 100 of the optical module 600 according to the first embodiment illustrated in FIG. 6 with the microlens 100 illustrated in FIG. 15.

For this reason, according to the optical module 600 according to the third embodiment, similar to the microlens 100 illustrated in FIG. 15, the oblique light beams, which have been incident to the lens units 111 to 115, are totally reflected when the oblique light beams reach the gaps 131a to 131d, and as a result, it is possible to suppress the oblique light beams from leaking to the neighboring lens units. For this reason, according to the optical module 600 according to the third embodiment, it is possible to reduce crosstalk occurring when the oblique light beams, which have been incident to the lens units 111 to 115, leak to the neighboring lens units, and thus it is possible to reduce deterioration in the optical signal caused by crosstalk.

According to the optical module 600 according to the third embodiment, similar to the microlens 100 illustrated in FIG. 15, the laser beams emitted from the VCSELs 151 to 155 may be shielded by the light shielding films 1301 to 1305 so as not to be incident to the neighboring lens units. For this reason, according to the optical module 600 according to the third embodiment, it is possible to reduce crosstalk occurring when the laser beams emitted from the VCSELs 151 to 155 are incident to the neighboring lens units, and thus it is possible to reduce deterioration in the optical signal caused by crosstalk.

According to the optical module 600 according to the third embodiment, similar to the microlens 100 illustrated in FIG. 15, the laser beams, which have been emitted from the convex lens portions 111a to 115a, may be shielded by the light shielding films 1301 to 1305 so as not to be incident to the neighboring PDs. For this reason, according to the optical module 600 according to the third embodiment, it is possible to reduce crosstalk occurring when the laser beams, which have been emitted from the convex lens portions 111a to 115a, are incident to the neighboring PDs, and thus it is possible to reduce deterioration in the optical signal caused by crosstalk.

In this way, according to the optical module 600 according to the third embodiment, similar to the optical module 600 according to the first embodiment, it is possible to suppress the oblique light beam, which has been incident to the lens unit, from leaking to the neighboring lens unit. In addition, according to the optical module 600 according to the third embodiment, the light shielding films are provided at the light incidence side of the lens unit of the microlens 100, and as a result, it is possible to suppress the oblique light beam, before being incident to the lens unit, from being incident to the neighboring lens unit. Alternatively, according to the optical module 600 according to the third embodiment, the light shielding film is provided at the light emission side of the lens unit of the microlens 100, and as a result, it is possible to suppress the oblique light beam, which has been emitted from the lens unit to the PD, from being incident to the neighboring PD. For this reason, according to the optical module 600 according to the third embodiment, it is possible to reduce deterioration in optical signal.

The second embodiment and the third embodiment may be combined. For example, in this case, the light shielding plates 801 to 805 may be provided between the adjacent lens units among the lens units 111 to 116, and the light shielding films 1301 to 1306 may be provided on the lens units 111 to 116.

As described above, according to the optical module according to the present disclosure, it is possible to suppress the oblique light beam, which has been incident to the lens, from leaking to the neighboring lens.

For example, recently, a printed board used for a server or a super computer is increased in speed and density. For this reason, in terms of interconnection by electric wiring in the related art, sufficient characteristics cannot be expected due to delays, damping, and interference of signals. To solve these problems, an optical signal is used for interconnection on the printed board. In the case where the optical signal is used for the interconnection on the printed board, multiple light sources such as VCSELs are disposed with a narrow pitch, and as a result, leaking light may be incident to the adjacent light receiving element. Crosstalk caused by the leaking light cannot be ignored in accordance with the increase in speed of signals.

In contrast, for example, according to the first embodiment, the gap 131a is provided between the lens unit 111 and the lens unit 112. For this reason, according to the first embodiment, it is possible to suppress the laser beam, which has been incident to the lens unit 111 from the VCSEL 151, as leaking light, from being incident to the lens unit 112 adjacent to the lens unit 111. In addition, similarly, it is possible to suppress the laser beam, which has been incident to the lens unit 112 from the VCSEL 152, as leaking light, from being incident to the lens unit 111 adjacent to the lens unit 112.

According to the second embodiment, the light shielding plate 801 is provided between the lens unit 111 and the lens unit 112. For this reason, according to the second embodiment, it is possible to suppress the laser beam emitted from the VCSEL 151 from being incident to the lens unit 112 adjacent to the lens unit 111. In addition, similarly, it is possible to suppress the laser beam emitted from the VCSEL 152 from being incident to the lens unit 111 adjacent to the lens unit 112.

According to the third embodiment, the light shielding film 1301 is provided on the lens unit 111, and the light shielding film 1302 is provided on the lens unit 112. For this reason, according to the third embodiment, it is possible to suppress the laser beam emitted from the VCSEL 151 from being incident to the lens unit 112 adjacent to the lens unit 111. In addition, similarly, it is possible to suppress the laser beam emitted from the VCSEL 152 from being incident to the lens unit 111 adjacent to the lens unit 112.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical module comprising:
a first light source configured to emit a first light beam;
a second light source configured to emit a second light beam; and
a lens member configured to include:
a first lens configured to transmit the first light beam,
a second lens provided adjacent to the first lens and configured to transmit the second light beam, and
a gap provided between the first lens and the second lens.

2. The optical module according to the claim 1,
wherein the first lens includes a first convex portion to which the first light beam is entered, a first intermediate portion through which the first light beam entered to the first convex portion is transmitted, and a second convex portion from which the first light beam transmitted through the first intermediate portion is emitted,
wherein the second lens includes a third convex portion to which the second light beam is entered, a second intermediate portion through which the second light beam entered to the third convex portion is transmitted, and a fourth convex portion from which the second light beam transmitted through the second intermediate portion is emitted, and
wherein the gap is provided between the first intermediate portion and the second intermediate portion.

3. The optical module according to claim 1,
wherein the lens member totally reflects a third light beam that reaches a first boundary surface between the first lens and the gap, and a fourth light beam that reaches a second boundary surface between the second lens and the gap, the third light beam and the fourth light beam being parts of the first light beam entered to the first lens and the second light beam entered to the second lens, respectively.

4. The optical module according to claim 1,
wherein the lens member further includes a light shielding plate configured to shield the first light beam emitted from the first light source so as not to be entered to the second lens, and shield the second light beam emitted from the second light source so as not to be entered to the first lens, between the first lens and the second lens.

5. The optical module according to claim 4,
wherein the first lens includes a first portion to which the first light beam emitted from the first light source is entered in the first lens,
wherein the second lens includes a second portion to which the second light beam emitted from the second light source is entered in the second lens, and
wherein the light shielding plate is provided between the first portion of the first lens and the second portion of the second lens.

6. The optical module according to claim 4,
wherein the light shielding plate is provided at a portion that couples the first lens and the second lens.

7. The optical module according to claim 1,
wherein the lens member further includes a first light shielding film configured to shield the second light beam so as not to be entered to the first lens, on the first lens, and a second light shielding film configured to shield the first light beam so as not to be entered to the second lens, on the second lens.

8. The optical module according to claim 7,
wherein the first lens includes a first portion to which the first light beam is entered to the first lens, the first light shieling film being provided at adjacent to the first portion,
wherein the second lens includes a second portion to which the second light beam is entered to the second lens, the second light shieling film being provided at adjacent to the second portion.

9. The optical module according to claim 1,
wherein the gap is a slit parallel to an optical axis of the first lens and an optical axis of the second lens.

10. The optical module according to claim 1,
wherein each of the first light source and the second light source is included in a plurality of n light sources,
wherein each of the first lens and the second lens is included in a plurality of n lenses,
wherein the gap is included in a plurality of n-1 gaps, and
wherein n is a natural number equal to or greater than two.

11. An optical module comprising:
a first light receiver configured to receive a first light beam;
a second light receiver configured to receive a second light beam; and
a lens member configured to include:
a first lens configured to transmit the first light beam and emit the first light beam to the first light receiver,
a second lens provided adjacent to the first lens and configured to transmit the second light beam and emit the second light beam to the second light receiver, and
a gap provided between the first lens and the second lens.

12. The optical module according to claim 11,
wherein the first lens includes a first convex portion to which the first light beam is entered, a first intermediate portion through which the first light beam entered to the first convex portion is transmitted, and a second convex portion from which the first light beam transmitted through the first intermediate portion is emitted to the first light receiver,
wherein the second lens includes a third convex portion to which the second light beam is entered, a second intermediate portion through which the second light beam entered to the third convex portion is transmitted, and a fourth convex portion from which the second light beam transmitted through the second intermediate portion is emitted to the second light receiver, and
wherein the gap is provided between the first intermediate portion and the second intermediate portion of the lens member.

13. The optical module according to claim 11,
wherein the lens member totally reflects a third light beam that reaches a first boundary surface between the first lens and the gap, and a fourth light beam that reaches a second boundary surface between the second lens and the gap, the third light beam and the fourth light beam being parts of the first light beam entered to the first lens and the second light beam entered to the second lens, respectively.

14. The optical module according to claim 11,
wherein the lens member further includes a light shielding plate configured to shield the first light beam emitted from the first lens so as not to be entered to the second light receiver, and shield the second light beam emitted from the second lens so as not to be entered to the first light receiver, between the first lens and the second lens.

15. The optical module according to claim 14,
wherein the first lens includes a first portion where the first light beam is emitted to the first light receiver,
wherein the second lens includes a second portion where the second light beam is emitted to the second light receiver, and
wherein the light shielding plate is provided between the first portion of the first lens and the second portion of the second lens.

16. The optical module according to claim 14,
wherein the light shielding plate is provided at a portion that couples the first lens and the second lens.

17. The optical module according to claim 11,
wherein the lens member further includes a first light shielding film configured to shield the second light beam so as not to be entered to the first light receiver, on the first lens, and a second light shielding film configured to shield the first light beam so as not to be entered to the second receiver, on the second lens.

18. The optical module according to claim 17,
wherein the first light shielding film is provided at adjacent to a portion where the first light beam is emitted to the first light receiver, and
wherein the second light shielding film is provided at adjacent to a portion where the second light beam is emitted to the second light receiver.

19. The optical module according to claim 11,
wherein each of the first light receiver and the second light receiver is included in a plurality of n light receivers,
wherein each of the first lens and the second lens is included in a plurality of n lenses,
wherein the gap is included in a plurality of n-1 gaps, and
wherein n is a natural number equal to or greater than two.
